(19) United States
(12) Patent Application Publication
(10) Pub. No.: US 2026/0312200 A1
(43) Pub. Date: Oct. 8, 2026

(54) POWER STORAGE DEVICE

(71) Applicant: TOYOTA JIDOSHA KABUSHIKI KAISHA, Toyota-shi (JP)

(72) Inventor: Tetsuo HARA, Toyota-shi (JP)

(73) Assignee: TOYOTA JIDOSHA KABUSHIKI KAISHA, Toyota-shi (JP)

(21) Appl. No.: 19/463,649

(22) Filed: Jan. 29, 2026

(30) Foreign Application Priority Data
Apr. 2, 2025 (JP) 2025-061028

(51) Int. Cl. H01M 50/242; H01M 10/653; H01M 50/204; H01M 50/264

(52) U.S. Cl. CPC H01M 50/242; H01M 10/653; H01M 50/204; H01M 50/264

(57) ABSTRACT

A power storage device includes a housing case, a stack, a thermally conductive material, and support members. Each of the support members includes a first support portion extending in an up-down direction, a second support portion extending in a stacking direction, and a bending portion where the first support portion intersects the second support portion. Each of the support members is fixed to the stack at the first support portion and to the housing case at the second support portion. The bending portion is in contact with the stack on a side farther away from the thermally conductive material than a center of the stack in a height direction. The first support portion extends from the bending portion toward the thermally conductive material.

### CROSS-REFERENCE TO RELATED APPLICATION

This application claims priority to Japanese Patent Application No. 2025-061028 filed on Apr. 2, 2025. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

Japanese Unexamined Patent Application Publication No. 2023-012176 (JP 2023-012176 A) discloses that a thermally conductive material is disposed between a cooler and the lower surface of a power storage module (also referred to as "battery module") including a plurality of power storage cells (also referred to as "battery cells") to remove heat generated in the power storage module. JP 2023-012176 A also discloses that the power storage module is attached such that the thermally conductive material is pressed by a pressing member.

### SUMMARY

When gas is generated inside the battery cell due to, for example, deterioration, heat generation, or overcharging to cause the battery cell to swell, however, the battery cell and the thermally conductive material may be separated, and the thermal conductivity of the thermally conductive material against the heat generated in the battery cell may decrease.

The present disclosure has been made in view of the above, and has an object to suppress separation of a battery cell and a thermally conductive material due to swelling of the battery cell.

A power storage device according to the present disclosure includes: a housing case; a stack including a plurality of stacked battery cells housed in the housing case; a thermally conductive material configured to transfer heat of the battery cells upward or downward from the stack; and support members that fix the housing case and the stack at positions where the support members sandwich the stack in a stacking direction. Each of the support members includes a first support portion extending in an up-down direction, a second support portion extending in the stacking direction, and a bending portion where the first support portion intersects the second support portion. Each of the support members is fixed to the stack at the first support portion and to the housing case at the second support portion. The bending portion is in contact with the stack on a side farther away from the thermally conductive material than a center of the stack in a height direction. The first support portion extends from the bending portion toward the thermally conductive material.

According to the present disclosure, it is possible to suppress separation of the battery cell and the thermally conductive material due to swelling of the battery cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a related-art power storage device;

FIG. 2 is a diagram showing an example of a power storage device according to an embodiment;

FIG. 3 is a diagram illustrating an attachment position of a bracket according to the embodiment;

FIG. 4 is a diagram illustrating movement of a stack in the event of swelling of battery cells according to the embodiment; and

FIG. 5 is a diagram illustrating attachment positions of side bands according to the embodiment.

### DETAILED DESCRIPTION OF EMBODIMENTS

A power storage device according to an embodiment of the present disclosure will be described with reference to the drawings. The components in the embodiment described below include components that can be readily replaced by those skilled in the art, or components that are substantially equivalent to those described in the embodiment.

The power storage device according to the embodiment may be, for example, a power storage device that is also called a battery or a battery pack and is mounted on a vehicle. The vehicle may be, for example, a battery electric vehicle (BEV), a hybrid electric vehicle (HEV), or a plug-in hybrid electric vehicle (PHEV).

The power storage device according to the embodiment includes, for example, a plurality of battery cells housed in a stacked state. The battery cell may be, for example, an all-solid-state battery or a liquid-based battery (also called "liquid electrolyte battery"), and may have any shape such as a cylindrical shape, a prismatic shape, or a pouch (laminate) shape. Referring to the drawings, a related-art power storage device and the power storage device according to the embodiment will be described below using prismatic all-solid-state batteries as an example, but the power storage device according to the present disclosure is not limited to certain batteries such as prismatic or all-solid-state batteries.

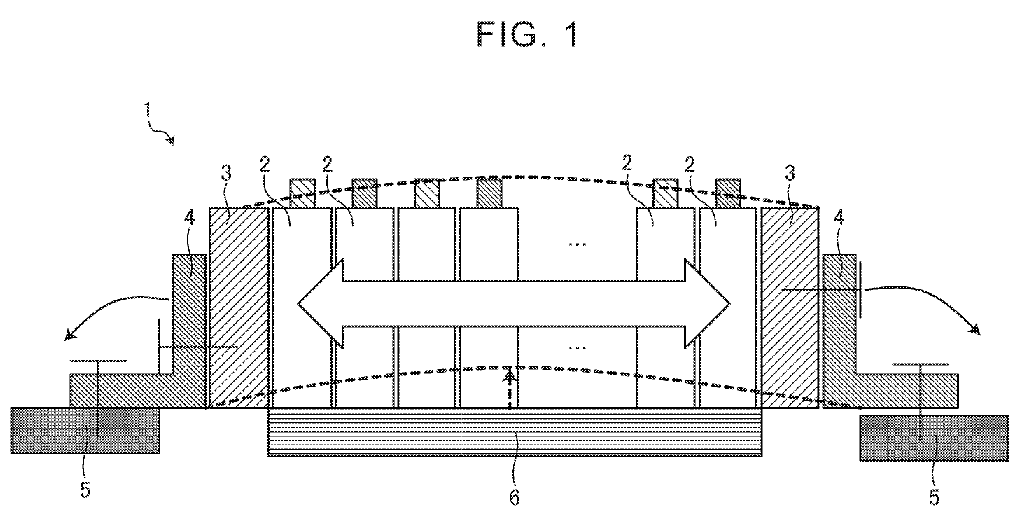

First, the related-art power storage device will be described. FIG. 1 is a diagram showing an example of the related-art power storage device. A power storage device 1 shown in FIG. 1 includes, for example, battery cells 2, end plates 3, brackets 4, a lower case 5, and a thermally conductive material 6. FIG. 1 is a schematic front view of the related-art power storage device 1. Therefore, the related-art power storage device 1 may include many more components such as busbars and reinforcing members in addition to the components shown in FIG. 1.

The battery cells 2 are housed, for example, in a stacked state in the power storage device 1 as shown in FIG. 1. The battery cells 2 may be housed, for example, in a stacked state in a housing case provided in the power storage device 1. The battery cell 2 may be, for example, an all-solid-state battery or a liquid-based battery as described above, and may have not only a prismatic shape but also a cylindrical shape, a pouch (laminate) shape, etc. For example, the stacked battery cells 2 may be collectively referred to as "stack."

The end plates 3 are, for example, components that are disposed at both ends of the stacked battery cells 2 in the stacking direction as shown in FIG. 1 to fix the battery cells 2 and limit their maximum displacement while allowing the battery cells 2 to swell. The end plates 3 shown in FIG. 1 have approximately the same size in the height direction as the battery cells 2, but the end plates are not limited to those shown in FIG. 1 and may have various sizes and shapes. The stacked battery cells 2 and the end plates 3 disposed at both ends of the battery cells 2 may be collectively referred to as "stack."

The brackets 4 are, for example, support members that are disposed at both ends of the stack including the battery cells 2 and the end plates 3 as shown in FIG. 1 to fix the stack and suppress excessive displacement of the stack due to vibration, impact, etc. As shown in FIG. 1, the brackets 4 are fastened to the end plates 3 and the lower case 5, for example, with screws to fix the stack including the battery cells 2 and the end plates 3 to the lower case 5. In this way, the brackets 4 fix the lower case 5 that is the housing case for the battery cells 2 and the stack including the battery cells 2 and the end plates 3, for example, at positions where the brackets 4 sandwich the stack in the stacking direction of the stack. In FIG. 1, for example, the T-shaped portions that penetrate the brackets 4 and are inserted into the end plates 3 and the lower case 5 indicate fastening points of the brackets 4 to the end plates 3 and the lower case 5. The stack including the battery cells 2 and the end plates 3 is fixed by the brackets 4, but the battery cells 2 and the end plates 3 may be fixed, for example, by components other than the brackets 4.

The lower case 5 is a component that covers the lower part of the power storage device 1. The lower case 5 may be, for example, a single exterior case (battery housing case) in combination with an upper case that covers the upper part of the power storage device 1.

The thermally conductive material 6 is, for example, a component that is made of silicone and is disposed below the battery cells 2 as shown in FIG. 1 to efficiently remove and dissipate heat generated in the battery cells 2. The thermally conductive material 6 can also transfer heat, for example, to a cooler disposed further below to perform cooling. The thermally conductive material 6 can also be used, for example, as an adhesive between the battery cells 2 and the cooler.

For example, when the battery cells 2 swell in the power storage device 1 shown in FIG. 1, a force that spreads in the stacking direction of the battery cells 2 (hereinafter sometimes referred to as "load along with swelling of battery cells 2") is generated as indicated by the double-headed arrow in FIG. 1. The load along with the swelling of the battery cells 2 is transmitted, for example, from the battery cells 2 to the end plates 3 and the brackets 4. The bracket 4 shown in FIG. 1 has an L-shape. A portion extending in a direction perpendicular to the stacking direction of the battery cells 2 is fixed to the end plate 3, and a portion extending in the stacking direction is fixed to the lower case 5.

Therefore, due to the load along with the swelling of the battery cells 2, the portions of the brackets 4 at both ends that extend in the perpendicular direction are bent in a V-shape, that is, to open upward, with the bending portions as the fulcra, for example, as indicated by the continuous single-headed arrows in FIG. 1. The bending portion is, for example, a portion where the portion of the bracket 4 that extends in the perpendicular direction intersects the portion of the bracket 4 that extends in the stacking direction of the battery cells 2. When the portions of the brackets 4 at both ends that extend in the perpendicular direction are bent, the stack including the battery cells 2 and the end plates 3 is displaced upward in a bow shape like a rainbow, for example, as indicated by the dashed lines in FIG. 1. In this state, for example, as indicated by the dashed single-headed arrow in FIG. 1, the battery cells 2 and the thermally conductive material 6 are separated, and the thermal conductivity of the thermally conductive material 6 against the heat generated in the battery cells 2 decreases.

In view of the above, one object of the present disclosure is, for example, to suppress separation of the battery cells 2 and the thermally conductive material 6 due to swelling of the battery cells 2.

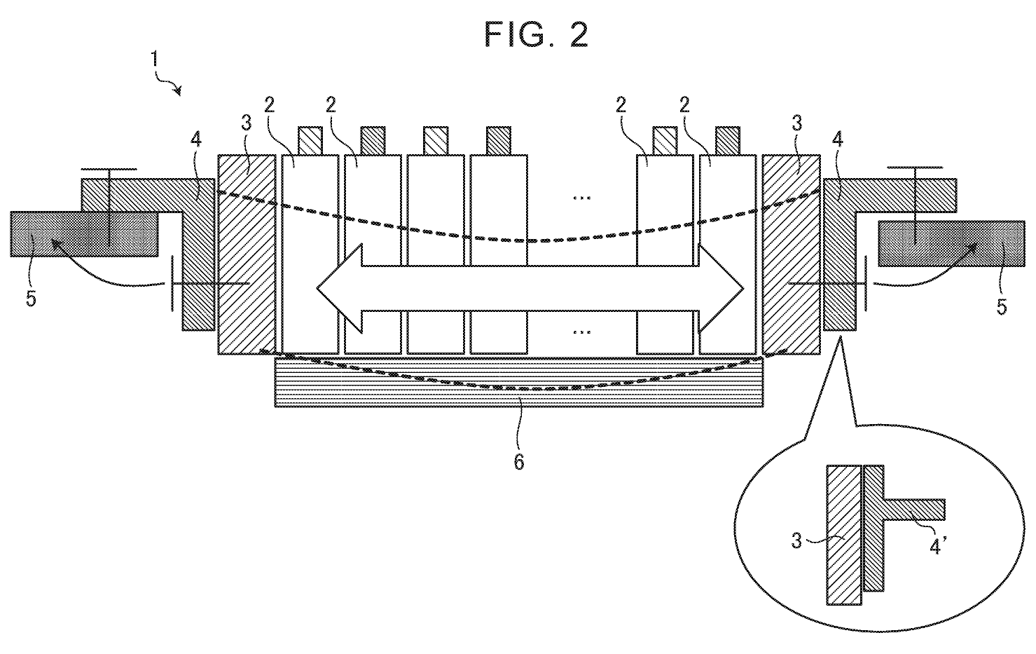

FIG. 2 is a diagram showing an example of the power storage device according to the embodiment. FIG. 2 is a schematic front view of a power storage device 1 according to the embodiment. Therefore, the power storage device 1 according to the embodiment may include many more components such as busbars and reinforcing members in addition to the components shown in FIG. 2. The power storage device 1 shown in FIG. 2 may include the same components as the power storage device 1 shown in FIG. 1, but, for example, the attachment method for the brackets 4 is different.

More specifically, for example, in the power storage device 1 shown in FIG. 2, the brackets 4 are attached such that the portions of the brackets 4 at both ends that extend in the perpendicular direction extend toward the thermally conductive material 6 contrary to the power storage device 1 shown in FIG. 1. Since the components of the power storage device 1 shown in FIG. 2 may be, for example, the same as the components of the power storage device 1 shown in FIG. 1, the above description of the battery cells 2, the end plates 3, the brackets 4, the lower case 5, and the thermally conductive material 6 shown in FIG. 1 can also be applied to the components shown in FIG. 2.

Due to the load along with the swelling of the battery cells 2, the portions of the brackets 4 at both ends that extend in the perpendicular direction are bent in an inverted V-shape, that is, to open downward, with the bending portions as the fulcra, for example, as indicated by the continuous single-headed arrows in FIG. 2. For example, when a portion of the bracket 4 at each end that extends in the perpendicular direction (up-down direction in FIG. 2) is defined as a first support portion and a portion of the bracket 4 at each end that extends in the stacking direction of the battery cells 2 is defined as a second support portion, the bending portion is a portion where the first support portion intersects the second support portion. For example, when the first support portions of the brackets 4 at both ends are bent due to the load along with the swelling of the battery cells 2, the stack including the battery cells 2 and the end plates 3 is displaced downward in a bow shape as indicated by the dashed lines in FIG. 2. In this state, for example, as shown in FIG. 2, the battery cells 2 are displaced to be pressed against the thermally conductive material 6. Therefore, it is possible to suppress separation of the battery cells 2 and the thermally conductive material 6 that occurs in the power storage device 1 shown in FIG. 1, and furthermore, suppress a decrease in thermal conductivity of the thermally conductive material 6 against the heat generated in the battery cells 2.

FIG. 2 shows an example in which the thermally conductive material 6 and the cooler are disposed below the stack including the battery cells 2 and the end plates 3, that is, below the battery cells 2. For example, the thermally conductive material 6 and the cooler may be disposed above the stack, that is, above the battery cells 2. In this case, the positional relationship of the components of the power storage device 1 shown in FIG. 2 is inverted in the up-down direction. Thus, it is possible to suppress separation of the battery cells 2 and the thermally conductive material 6 when the battery cells 2 swell.

The bracket 4 shown in FIG. 2 has an L-shape. As in the case of a bracket 4′ shown in the balloon in FIG. 2, the portion extending in the perpendicular direction may extend slightly in the opposite direction to the thermally conductive material 6. However, the portion may extend only "slightly." For example, if the portion of the bracket 4′ that extends in the opposite direction to the thermally conductive material 6 is equal to or longer than the portion that extends toward the thermally conductive material 6, in the event of swelling of the battery cells 2, the portion that extends toward the thermally conductive material 6 may hardly be bent or the portion that extends in the opposite direction to the thermally conductive material 6 may be bent. In this case, there is a possibility that the effect of suppressing separation of the battery cells 2 and the thermally conductive material 6 cannot be achieved. For example, the attachment positions of the brackets 4 may also affect the effect of suppressing separation of the battery cells 2 and the thermally conductive material 6.

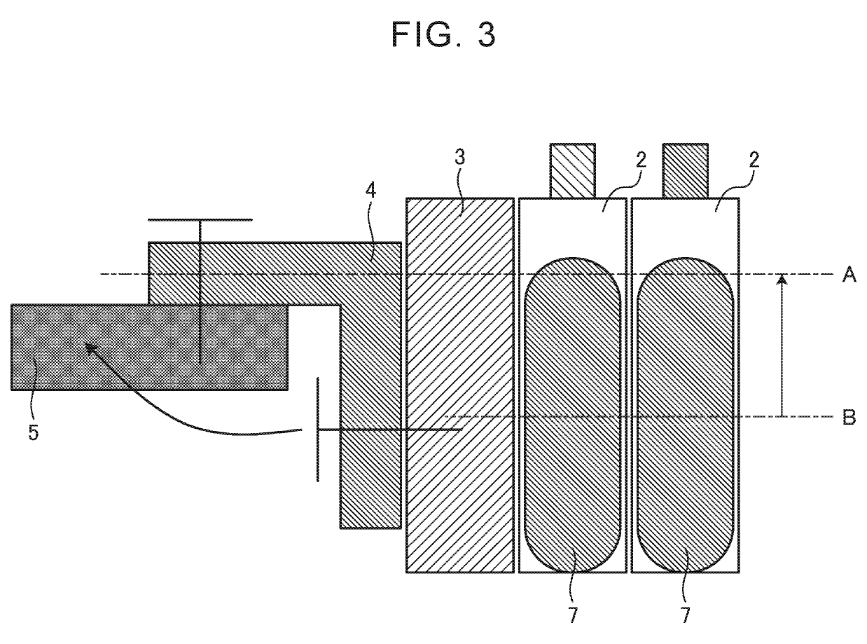

FIG. 3 is a diagram illustrating the attachment positions of the brackets according to the embodiment. FIG. 3 shows an example in which the left part of the power storage device 1 shown in FIG. 2 is snipped out to describe the attachment position of the bracket 4. In FIG. 3, position A is, for example, a position of the bending portion of the bracket 4 in the height direction, and is an approximate attachment position of the bracket 4 to the lower case 5 in the height direction. Position B is, for example, a center position of an electrode assembly 7 in the battery cell 2 in the height direction.

To achieve the effect of suppressing separation of the battery cells 2 and the thermally conductive material 6, the bracket 4 is attached, for example, such that position A is higher than position B as shown in FIG. 3. FIG. 3 also shows an example in which the thermally conductive material 6 and the cooler are disposed below the battery cells 2. For example, when the thermally conductive material 6 and the cooler are disposed above the battery cells 2, the bracket 4 is attached such that position A is lower than position B.

In this way, the support member that is the bracket 4 is attached, for example, such that the first support portion is fixed to the stack including the battery cells 2 and the end plates 3 and the second support portion is fixed to the housing case that is the lower case 5. The bracket 4 is attached, for example, such that the bending portion where the first support portion intersects the second support portion is in contact with the stack on the side farther away from the thermally conductive material 6 than the center of the stack in the height direction and the first support portion extends from the bending portion toward the thermally conductive material 6. The fastening point between the first support portion and the stack is present on the side closer to the thermally conductive material 6 than the center of the stack in the height direction.

By attaching the bracket 4 as described above, the portion of the bracket 4 that extends in the perpendicular direction is bent with the bending portion as the fulcrum, for example, as indicated by the arrow in FIG. 3 due to the load along with the swelling of the battery cells 2. Thus, it is possible to achieve the effect of suppressing separation of the battery cells 2 and the thermally conductive material 6. When the bracket 4′ shown in FIG. 2 is attached in a positional relationship similar to the attachment position of the bracket 4 described above, it is possible to achieve the effect of suppressing separation of the battery cells 2 and the thermally conductive material 6 in the event of swelling of the battery cells 2.

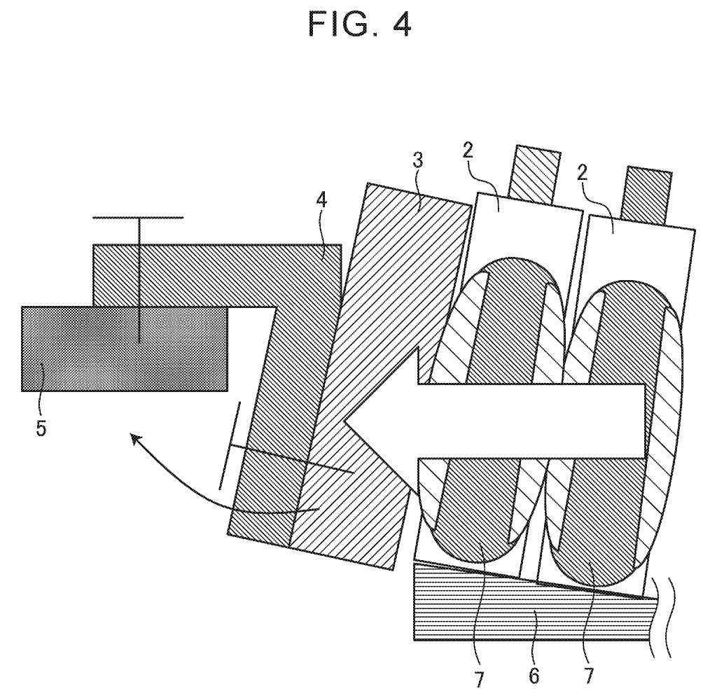

Next, movement of the stack including the battery cells 2 and the end plates 3 in the event of swelling of the battery cells 2 will be described with reference to FIG. 4. FIG. 4 is a diagram illustrating the movement of the stack in the event of swelling of the battery cells according to the embodiment. When the battery cells 2 each including the electrode assembly 7 swells, for example, a force that spreads in the stacking direction of the battery cells 2 is generated as indicated by the wide arrow in FIG. 4, and the first support portions of the brackets 4 located at both ends in the stacking direction of the stack including the swollen battery cells 2 are pressed by the stack and bent outward in the stacking direction with the bending portions as the fulcra as indicated by the narrow arrow in FIG. 4. When the first support portions are bent, for example, the battery cells 2 and the end plates 3 are displaced obliquely along the first support portions as shown in FIG. 4 to apply an additional load to the first support portions. Due to the displacement of the battery cells 2 and the end plates 3, the entire stack including the battery cells 2 and the end plates 3 is displaced downward in a bow shape as shown in FIG. 2.

At this time, for example, the battery cells 2 at the ends of the stack including the battery cells 2 and the end plates 3 may be lifted and separated from the thermally conductive material 6. Therefore, for example, the thickness of the thermally conductive material 6 is made larger at the ends of the stack in the stacking direction of the battery cells 2 than at the center of the stack. Thus, even if the battery cells 2 at the ends of the stack are lifted, the thermally conductive material 6 is deformed to follow the battery cells 2. Accordingly, close contact between the battery cells 2 and the thermally conductive material 6 can be ensured.

The deformation of the thermally conductive material 6 to follow the battery cells 2 means, for example, that the thermally conductive material 6 changes its shape in accordance with the displacement of the battery cells 2. More specifically, for example, even if a gap is created between the battery cells 2 and the thermally conductive material 6 due to the displacement of the battery cells 2, the thermally conductive material 6 expands to fill the gap. The thermally conductive material 6 is made of a highly compressible material such as silicone. Therefore, the thermally conductive material 6 can change its shape in this way. By increasing the thickness of the thermally conductive material 6 at the ends in the stacking direction where the battery cells 2 may be lifted, the thermally conductive material 6 is deformed to follow the battery cells 2, for example, as shown in FIG. 4 (in the example of FIG. 4, the upper surface of the thermally conductive material 6 is deformed obliquely in accordance with the oblique displacement of the battery cells 2), and close contact between the battery cells 2 and the thermally conductive material 6 can be ensured. For example, even though the thickness of the thermally conductive material 6 varies between the center and the ends, the thermally conductive material 6 is disposed to be pressed by the battery cells 2, and therefore the upper surface of the thermally conductive material 6 (particularly at the thicker ends) is compressed under normal conditions and is flat as shown in FIG. 2.

The power storage device 1 may include, for example, side bands that fix the battery cells 2. These side bands may affect the effect of suppressing separation of the battery cells 2 and the thermally conductive material 6.

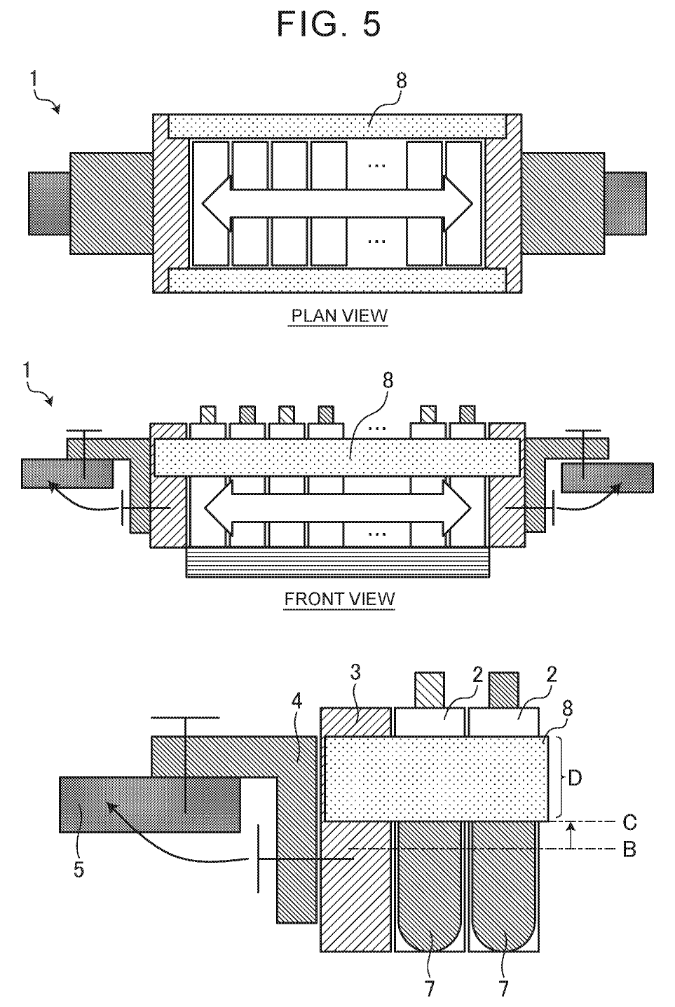

FIG. 5 is a diagram illustrating attachment positions of the side bands according to the embodiment. The front view and the plan view shown in FIG. 5 are schematic views of the power storage device 1 to which side bands 8 are attached as seen from the front and the top, respectively. The double-headed arrows in the front view and the plan view of FIG. 5 indicate, for example, loads along with swelling of the battery cells 2.

The side bands 8 are also called, for example, restraining bands, and are components that are attached to fix the stack including the battery cells 2 and the end plates 3 from both sides as shown in the front view and the plan view of FIG. 5. For example, depending on the attachment positions and the sizes of the side bands 8, the displacement of the battery cells 2 and the end plates 3 as shown in FIG. 4 may be limited, leading to a possibility that the effect of suppressing separation of the battery cells 2 and the thermally conductive material 6 cannot be achieved. Therefore, the attachment positions and the sizes of the side bands 8 that achieve the suppression effect will be described.

In the lower part of FIG. 5, position B is, for example, the center position of the electrode assembly 7 in the battery cell 2 in the height direction as in FIG. 3. Position C is, for example, an approximate attachment position of the side band 8 in the height direction. To achieve the effect of suppressing separation of the battery cells 2 and the thermally conductive material 6, the side band 8 is attached, for example, such that position C is higher than position B as shown in the lower part of FIG. 5. FIG. 5 also shows an example in which the thermally conductive material 6 and the cooler are disposed below the battery cells 2. For example, when the thermally conductive material 6 and the cooler are disposed above the battery cells 2, the side band 8 is attached such that position C is lower than position B. A size D of the side band 8 in the height direction is, for example, set smaller than half the size of the battery cell 2 in the height direction.

In this way, the stack including the battery cells 2 and the end plates 3 includes the restraining bands that are the side bands 8, and is attached such that the restraining bands are present on the side farther away from the thermally conductive material 6 than the center of the stack in the height direction.

With the side bands 8 described above, it is possible to achieve the effect of suppressing separation of the battery cells 2 and the thermally conductive material 6 without excessively limiting the displacement of the battery cells 2 and the end plates 3 as shown in FIG. 4.

The power storage device 1 according to the embodiment described above includes: the housing case that is the lower case 5; the stack including the stacked battery cells 2 housed in the housing case; the thermally conductive material 6 configured to transfer heat of the battery cells 2 upward or downward from the stack; and the support members that are the brackets 4 that fix the housing case and the stack at the positions where the support members sandwich the stack in the stacking direction. Each of the support members includes the first support portion extending in the up-down direction, the second support portion extending in the stacking direction of the stack, and the bending portion where the first support portion intersects the second support portion. Each of the support members is fixed to the stack at the first support portion and to the housing case at the second support portion. The bending portion is in contact with the stack on the side farther away from the thermally conductive material 6 than the center of the stack in the height direction. The first support portion extends from the bending portion toward the thermally conductive material 6. Therefore, the power storage device 1 according to the embodiment can suppress separation of the battery cells 2 and the thermally conductive material 6 that occurs due to swelling of the battery cells 2, and furthermore, suppress a decrease in thermal conductivity of the thermally conductive material 6 against the heat generated in the battery cells 2.

In the power storage device 1 according to the embodiment, the fastening point between the first support portion and the stack is present on the side closer to the thermally conductive material 6 than the center of the stack in the height direction. Therefore, the first support portion is bent with the bending portion as the fulcrum due to the load along with the swelling of the battery cells 2. Thus, the power storage device 1 according to the embodiment can achieve the effect of suppressing separation of the battery cells 2 and the thermally conductive material 6.

In the power storage device 1 according to the embodiment, the thickness of the thermally conductive material 6 is larger at the ends of the stack than at the center of the stack in the stacking direction of the stack. Thus, even if the battery cells 2 at the ends of the stack are lifted, the thermally conductive material 6 is deformed to follow the battery cells 2. Accordingly, the power storage device 1 according to the embodiment can ensure close contact between the battery cells 2 and the thermally conductive material 6.

In the power storage device 1 according to the embodiment, the stack includes the restraining band that is the side band 8, and the restraining band is present on the side farther away from the thermally conductive material 6 than the center of the stack in the height direction. Therefore, the restraining band does not excessively limit the displacement of the battery cells 2 and the end plates 3 due to the load along with the swelling of the battery cells 2. Thus, the power storage device 1 according to the embodiment can achieve the effect of suppressing separation of the battery cells 2 and the thermally conductive material 6.

In the power storage device 1 according to the embodiment, when the battery cells 2 swell, the first support portion located at each end of the stack in the stacking direction is pressed against the stack including the swollen battery cells 2, and is bent outward in the stacking direction with the bending portion as the fulcrum. Therefore, in the power storage device 1 according to the embodiment, when the battery cells 2 swell, the battery cells 2 are displaced to be pressed against the thermally conductive material 6. Thus, separation of the battery cells 2 and the thermally conductive material 6 can be suppressed.

The power storage device 1 according to the embodiment may be an all-solid-state battery or a liquid-based battery.

Further effects and modifications can be readily derived by those skilled in the art. Therefore, the broader aspects of the present disclosure are not limited to the specific details and exemplary embodiments shown and described above. Accordingly, various modifications may be made without departing from the spirit or scope of the general concept of the disclosure as defined by the appended claims and their equivalents.

What is claimed is:

1. A power storage device comprising:
a housing case;
a stack including a plurality of stacked battery cells housed in the housing case;
a thermally conductive material configured to transfer heat of the battery cells upward or downward from the stack; and
support members that fix the housing case and the stack at positions where the support members sandwich the stack in a stacking direction, wherein
each of the support members includes a first support portion extending in an up-down direction, a second support portion extending in the stacking direction, and a bending portion where the first support portion intersects the second support portion,
each of the support members is fixed to the stack at the first support portion and to the housing case at the second support portion,
the bending portion is in contact with the stack on a side farther away from the thermally conductive material than a center of the stack in a height direction, and
the first support portion extends from the bending portion toward the thermally conductive material.

2. The power storage device according to claim 1, wherein a fastening point between the first support portion and the stack is present on a side closer to the thermally conductive material than the center of the stack in the height direction.

3. The power storage device according to claim 1, wherein a thickness of the thermally conductive material is larger at ends of the stack than at a center of the stack in the stacking direction.

4. The power storage device according to claim 1, wherein:
the stack includes a restraining band; and
the restraining band is present on a side farther away from the thermally conductive material than the center of the stack in the height direction.

5. The power storage device according to claim 1, wherein when the battery cells swell, the first support portion located at each end of the stack in the stacking direction is pressed against the stack including the swollen battery cells, and is bent outward in the stacking direction with the bending portion as a fulcrum.
